(19) United States
(12) Patent Application Publication
(10) Pub. No.: US 2013/0087575 A1
(43) Pub. Date: Apr. 11, 2013

(54) Granular seasoning dispenser and method

(71) Applicants: Paul G. Simmons, Glen Ellyn, IL (US); Melissa Enge, Basel (CH); Pia Ganner, Bad Sackingen (DE); Iris Prehn, Berlin (DE); Guo De Huang, DaLiang Town (CN); Ying Zhou Zheng, Heshan City (CN); Jeffrey Craig Watson, Franklin, TN (US)

(72) Inventors: Paul G. Simmons, Glen Ellyn, IL (US); Melissa Enge, Basel (CH); Pia Ganner, Bad Sackingen (DE); Iris Prehn, Berlin (DE); Guo De Huang, DaLiang Town (CN); Ying Zhou Zheng, Heshan City (CN); Jeffrey Craig Watson, Franklin, TN (US)

(21) Appl. No.: 13/317,081

(22) Filed: Oct. 7, 2011

(51) Int. Cl. B67D 7/30; B23P 11/00

(52) U.S. Cl. 222/1; 222/71; 29/428

(57) ABSTRACT

A device and method are provided for metered dispensing of granular seasoning material. The device comprises a reservoir including a dispensing outlet, a metered dispensing member having an axis and a metering chamber comprising a peripheral cavity in the metered dispensing member, the metered dispensing member mounted for axial linear movement relative to the reservoir through the dispensing outlet to and from a filling position, in which the metering chamber is in communication with the interior of the reservoir, and a dispensing position, in which the metering chamber is in communication with the exterior of the reservoir, to permit gravity dispensing of a metered quantity of material from the metering chamber. Preferably, an actuation assembly for movement of the dispensing member comprises biasing means. A diffuser may be connected to the exterior of the reservoir below the dispensing outlet for evenly distributing dispensed material onto a target area.

### FIELD OF THE INVENTION

The present invention relates to devices and methods for metered dispensing of particulate materials. More particularly, it relates to metered granular seasoning dispensers, methods of using the dispensers to evenly dispense a consistent quantity of granular seasoning onto a plurality of food items, and methods of making the dispensers.

### BACKGROUND OF THE INVENTION

In the high-volume, quick-service food industry, uniformity of product quality is essential, as is efficiency of product preparation, to meet customer expectations and remain competitive in terms of food quality and price and speed of service. One key aspect of uniform product taste is the uniform application of any granular seasoning to a particular food item, in terms of a consistent quantity of seasoning applied to each food item and an even distribution of the seasoning over the surface of the food item.

Existing granular seasoning dispensers have significant shortcomings with respect to uniformity of dispensed quantity, speed of dispensing, and/or evenness of dispensing distribution. For example, the evenly spaced apart apertures of the pour opening of a traditional household salt shaker only provide for relatively even distribution over an area roughly the size and shape of the pour opening, and the lack of metered flow control moreover makes such a shaker clearly inadequate to provide a consistent quantity of seasoning on each of a plurality of food items. On the other hand, previous attempts to provide a metered seasoning dispenser have resulted in compromises to the ease and quickness of operation as well as the evenness of distribution. For example, one existing type of metered seasoning dispenser employs a metering chamber in direct communication with a dispensing outlet, the metering chamber separated from a much larger reservoir by a system of baffles, such that holding the dispenser in a filling position causes the metering chamber to be filled with a metered quantity of seasoning from the reservoir, inverting the dispenser from the filling position to a dispensing position causes only the metered quantity of seasoning to be dispensed, and then inverting the dispenser from the dispensing position back to the filling position causes the metering chamber to be filled again. This system is reasonably effective for providing a consistent quantity of seasoning for each dispensing cycle. However, the repeated action of inverting the dispenser back and forth to season a plurality of food items is somewhat awkward and time consuming, while the rotational inverting motion of the entire dispenser imparts trajectories to particles exiting the dispensing outlet that are difficult to predict and control, thus jeopardizing the even distribution of particles onto the food item.

A need therefore exists for an improved metered dispenser for granular seasoning that is quick and comfortable to operate and that provides consistently uniform distribution of seasoning onto the surface of a food item having a different size than that of a cross-sectional flow profile of granular seasoning material initially exiting the dispenser. It will be understood that “different shape,” as used herein, includes both geometrically dissimilar shapes and geometrically similar shapes that differ only in scale.

### BRIEF SUMMARY OF THE INVENTION

In accordance with one aspect of the present invention, a device for metered dispensing of granular seasoning material is provided. The device comprises a reservoir with a dispensing outlet, the reservoir adapted to contain granular seasoning material in an interior thereof, and a dispensing mechanism for causing a metered amount of material to pass out of the reservoir. The dispensing mechanism includes a metered dispensing member having an axis and a metering chamber comprising a peripheral cavity in the metered dispensing member, the metered dispensing member mounted for axial linear movement relative to the reservoir through the dispensing outlet to and from a filling position and a dispensing position. In the filling position, at least a portion of the metering chamber is disposed in communication with the reservoir for receiving into the metering chamber seasoning material contained in the reservoir, and in the dispensing position, at least a portion of the metering chamber is disposed to the exterior of the reservoir. The metering chamber is configured to permit gravity dispensing of particulate seasoning from the metering chamber when in the dispensing position.

In one embodiment of the device, the peripheral cavity in the metered dispensing member substantially encircles the axis of the metered dispensing member.

In another embodiment, the device further comprises a biasing member axially biasing the metered dispensing member to a biased position. The biased position may be either the filling position or the dispensing position. A manual actuator operatively connected to the metered dispensing member is adapted, when actuated, to move the metered dispensing member from the biased position to an actuation position, and, when released, to permit the biasing member to return the metered dispensing member to the biased position.

In still another embodiment, a lower portion of the metered dispensing member is disposed below the metering chamber, and when the metered dispensing member is in the filling position, the lower portion blocks the dispensing outlet to at least substantially prevent particulate material from passing through the dispensing outlet from the interior of the reservoir. An upper portion of the metered dispensing member is disposed above the metering chamber and when the metered dispensing member is in the dispensing position, the upper portion blocks the dispensing outlet to at least substantially prevent particulate material from passing through the dispensing outlet from the interior of the reservoir. In this manner, when the metered dispensing member is in the filling position, no particulate material is permitted to be dispensed, and when it is in the dispensing position, only the particulate material in the metering chamber is permitted to be dispensed. Optionally, the lower and upper portions of the metered dispensing member each have a peripheral portion with a cross-sectional shape matching a shape of the dispensing outlet, the peripheral portion configured to pass through the dispensing outlet with at least substantially no peripheral clearance to cover the dispensing outlet when overlapping the peripheral profile of the dispensing outlet. In this embodiment, the dispensing outlet may comprise a sleeve having an axial length, a cross-sectional shape of the sleeve defining said shape of the dispensing outlet and being at least substantially uniform along the axial length. When the metered dispensing member is at an intermediate position between the filling position and the dispensing position, the sleeve is configured to cover the metering chamber to at least substantially prevent particulate material from flowing into the metering chamber from the reservoir or out of the metering chamber to the exterior of the reservoir. If desired, the cross-sectional shape of the peripheral portions of the metered dispensing member and the shape of the dispensing outlet may be generally circular, as when a target food item for the seasoning material is itself circular, as in a typical round hamburger patty. Alternatively, for seasoning generally polygonal food items, it may be desired that the cross-sectional shape of the peripheral portions of the metered dispensing member and the shape of the dispensing outlet be generally polygonal. For example, the outlet may be square for seasoning a square hamburger patty.

In yet another embodiment, in which the dispensing outlet is generally horizontally disposed in a bottom wall of the reservoir, the device further comprises a diffuser disposed outside of the reservoir and spaced downwardly from the dispensing outlet. The diffuser includes a particle flow baffle member, the baffle member including a ring portion having a shape generally geometrically similar to, coaxial with, and larger than the shape the dispensing outlet. The ring portion defines a generally open interior area, and the baffle member is configured to contact at least some of a metered quantity of particles dispensed from the metering chamber in the dispensing position and to alter the paths of at least some of the particles to cause the quantity of particles to be generally uniformly dispensed onto a target area generally located below the diffuser. Optionally, the ring portion is configured to direct at least some of the particles to fall through the interior area and at least some of the particles to fall outside the periphery of the ring portion. This is desired when the food item to be seasoned has an area larger than the dispensing outlet, without an interior void area; that is to say, when the food item is shaped more like a hamburger patty than, for instance, a bagel. Typically, the target area has a shape generally geometrically similar to, coaxial with, and larger than the shape of the combined area of the ring portion and interior area. To guide some of the particulate material falling onto the ring portion toward the center of the interior area, the baffle member may further comprise a plurality of spokes generally extending from the ring portion to the center of the interior area. Further, the spokes may be connected to a hub disposed proximate to the center of the interior area, and an aperture may extending longitudinally through the hub to permit some particles to fall through the aperture at or near the center of the interior area.

The ring portion itself may comprise an upper outer surface and a generally opposed upper inner surface defining the outer and inner periphery of the ring portion, respectively. The upper outer and inner surfaces may meet at an apex to define a central ridge. To permit some of the particles to fall straight through the ring portion at or near the radial location of the central ridge without being redirected, a plurality of apertures may extend longitudinally through the ring portion, the central ridge being discontinuous and comprising a plurality of central ridge segments extending between adjacent apertures. Additionally, to allow some of the particles to fall straight past the ring portion at locations radially inward or outward of the ring portion apertures without being redirected, the ring portion may have a radial width that is generally greater at the angular locations of the apertures than at the angular locations of the central ridge segments.

In still another embodiment, the dispensing outlet is formed in a detachable portion of the reservoir and the reservoir is adapted for detaching of the detachable portion and attaching of a different detachable portion including a different dispensing outlet having a different shape. The dispensing member may also be detachable from the device and the device adapted for attachment of a different dispensing member having a shape corresponding to the different dispensing outlet. Further, in the embodiment including a diffuser the diffuser may be detachable from the device and the device adapted for attachment of a different diffuser having a different shape. These modular aspects of devices according to the invention are advantageous for selectively adapting the device to seasoning food items of various shapes.

In yet another embodiment, a handle is attached to the reservoir proximate to the manual actuator, the handle and manual actuator configured to permit a user to support the device by grasping the handle with one hand while actuating the actuator with the same hand. For example, the manual actuator may comprise a thumb lever disposed above the handle, the thumb lever mounted pivotally with respect to the reservoir, pivotally and slidingly connected to a dispensing shaft that is integrally attached to the metered dispensing member, and configured to be pivotally depressed by a downward force applied by a user's thumb to cause the dispensing shaft and metered dispensing member to move downward in an axial direction to move the metered dispensing member to the dispensing position.

In some preferred embodiments of the device, the reservoir is composed of a translucent material so that the amount of particulate material in the reservoir is visually discernible, and/or the reservoir, dispensing member, and manual actuator are composed of substantially rigid materials. For example, the reservoir may be composed of a food grade plastic, which may be translucent and/or rigid.

In another aspect of the invention, a method is provided for metered dispensing of particulate material, which may for example be a granular seasoning material, onto a target area, which may for example be a food item. The method comprises providing a device substantially as described above, actuating the manual actuator of the device to move the manual actuator from a default position to an actuation position, and returning the manual actuator to the default position. The actuator default position corresponds to an initial one of the filling position and the dispensing position of the metered dispensing member, and the actuation position corresponds to the other of the filling position and the dispensing position. Thus, if the dispensing member is initially in the filling position, actuating the actuator will dispense a metered quantity of particulate material and permit it to fall onto a target area, and returning the actuator to the default position will allow the dispensing member to fill again. Alternatively, if the dispensing member is initially in the dispensing position (and thus typically empty), actuating the actuator will move the dispensing member to the filling position to allow the dispensing member to fill with a metered quantity of material, and returning the actuator to the default position will move the dispensing member to the dispensing position to dispense the metered quantity of material.

In embodiments of the method that include providing a modular embodiment of the device, the method may further include selecting a shape of dispensing outlet and dispensing member, and/or a shape of diffuser, as desired, and substituting one or more detachable portions into and out of the device accordingly.

In yet another aspect of the present invention, a method is provided for making a device for metered dispensing of particulate material. The method includes forming a reservoir adapted to contain granular seasoning particles in an interior thereof, forming a dispensing outlet in the reservoir, forming a metered dispensing member having structure and function substantially as described above; movably mounting the metered dispensing member within the reservoir for bidirectional axial movement through the dispensing outlet to and from a filling position and a dispensing position, and forming the above-described metering chamber in the metered dispensing member by creating a peripheral cavity in the metered dispensing member substantially encircling the axis of the metered dispensing member. In particular embodiments of the method of making a metered dispensing device for particulate material, various additional components of the device, including the manual actuator, biasing member, and diffuser, are formed to have the structures functions substantially as described above.

### BRIEF DESCRIPTION OF THE DRAWINGS

FIG. 1 is a perspective view of a dispensing device according to the invention.

FIG. 2a is an exploded perspective view of the dispensing device shown in FIG. 1.

FIG. 2b is a cross-sectional elevation view of the dispensing device shown in FIG. 1, partially assembled.

FIG. 2c is a cross-sectional elevation view of the dispensing device shown in FIG. 1, further assembled.

FIG. 2d is a still further assembled cross-sectional elevation view of the dispensing device shown in FIG. 1, still further assembled.

FIG. 3 is a cross-sectional elevation view of the dispensing device shown in FIG. 1, fully assembled, in the filling position.

FIG. 4 is a cross-sectional elevation view of the dispensing device shown in FIG. 3, in the dispensing position.

FIG. 5 is a cross-sectional elevation view of the dispensing device shown in FIG. 3, in a partially actuated position at which neither filling nor dispensing occurs.

FIG. 6 is an enlarged perspective view of a diffuser according to one embodiment of the invention.

FIG. 7 is a partial cut-away perspective view of the diffuser shown in FIG. 6 illustrating flow paths for particulate material over, through, and around the diffuser.

FIG. 8 is an enlarged perspective view of a dispensing member according to one embodiment of the invention.

FIG. 9 is an enlarged, fragmentary cross-sectional elevation view of a portion of the device showing the dispensing member in the filling position.

FIG. 10 is an enlarged, fragmentary cross-sectional elevation view of a portion of the device showing the dispensing member in the dispensing position, further illustrating the dispensing of granular seasoning material onto the surface of a food item.

FIG. 11 is an exploded perspective view of a dispensing member, dispensing outlet, and diffuser according to an alternative embodiment of the invention.

FIG. 12 is a cross-sectional elevation view of another dispensing member and diffuser according to another alternative embodiment of the invention.

FIG. 13 is a top plan view of the diffuser shown in FIG. 12.

### DETAILED DESCRIPTION OF THE INVENTION

With reference to the Figures generally, in accordance with the present invention, an easy to use device and method for quick dispensing of an evenly distributed, metered quantity of particulate material from a steady position are shown and described. In addition, a method of making the device is described.

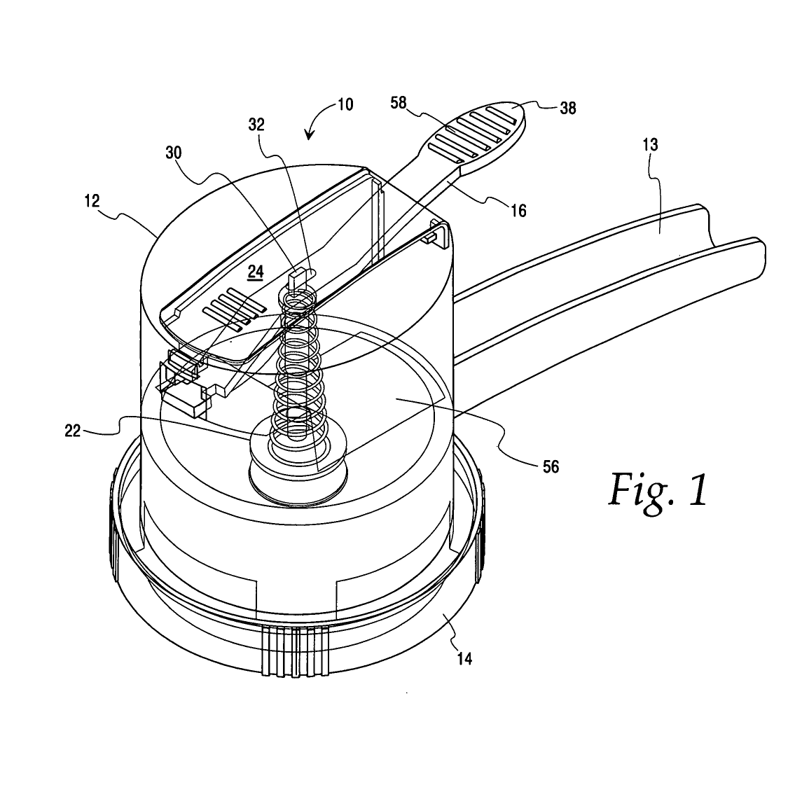

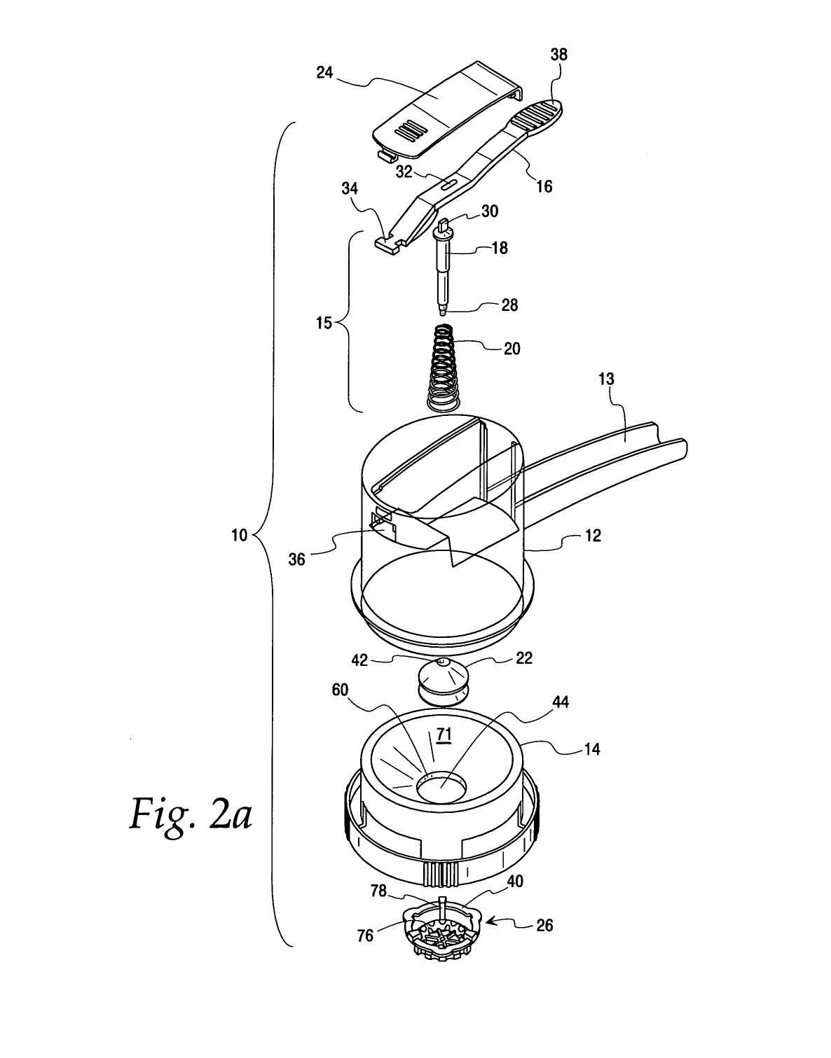

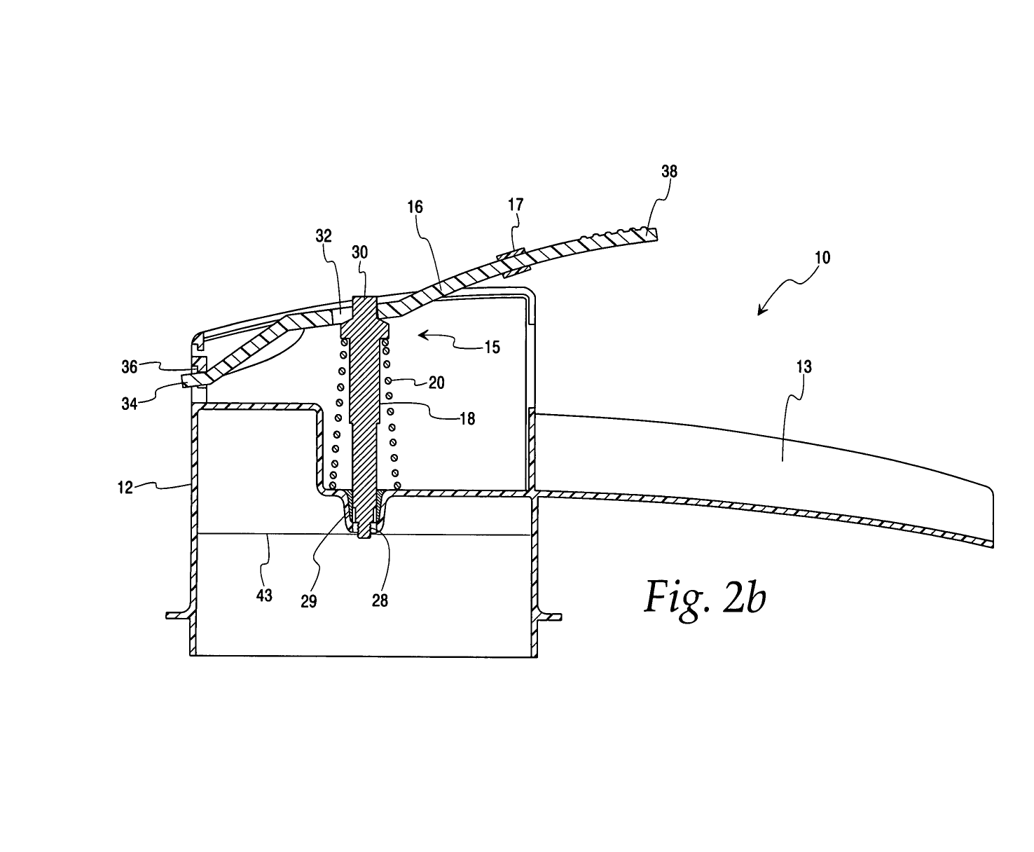

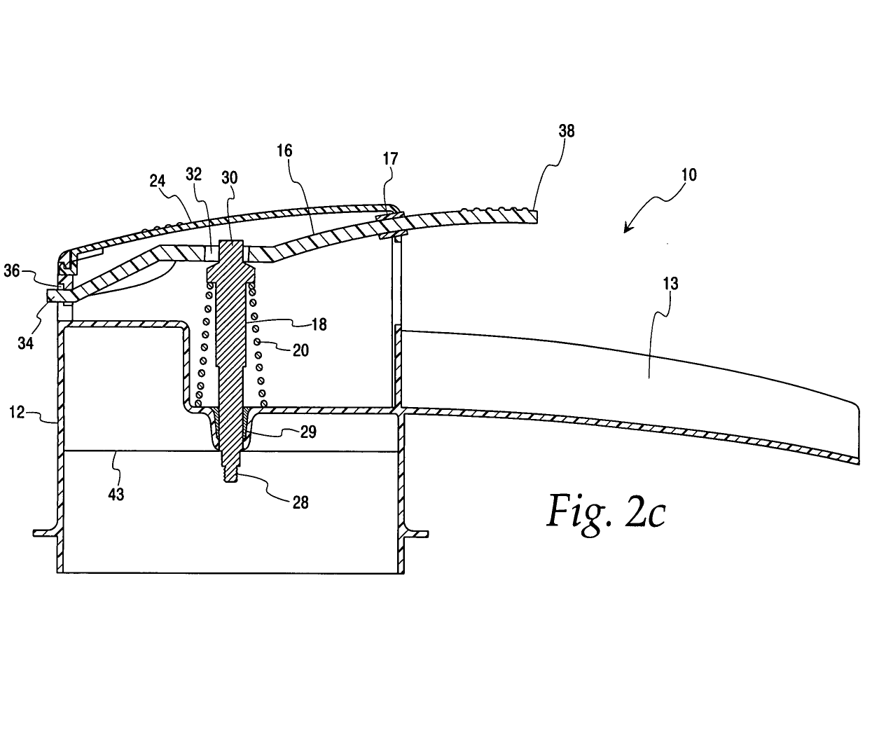

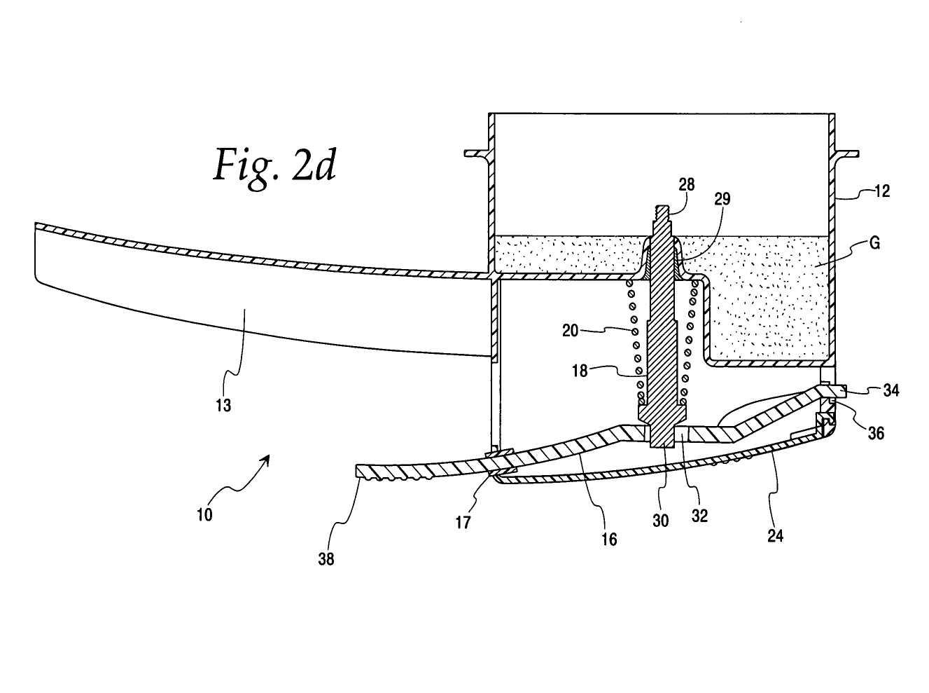

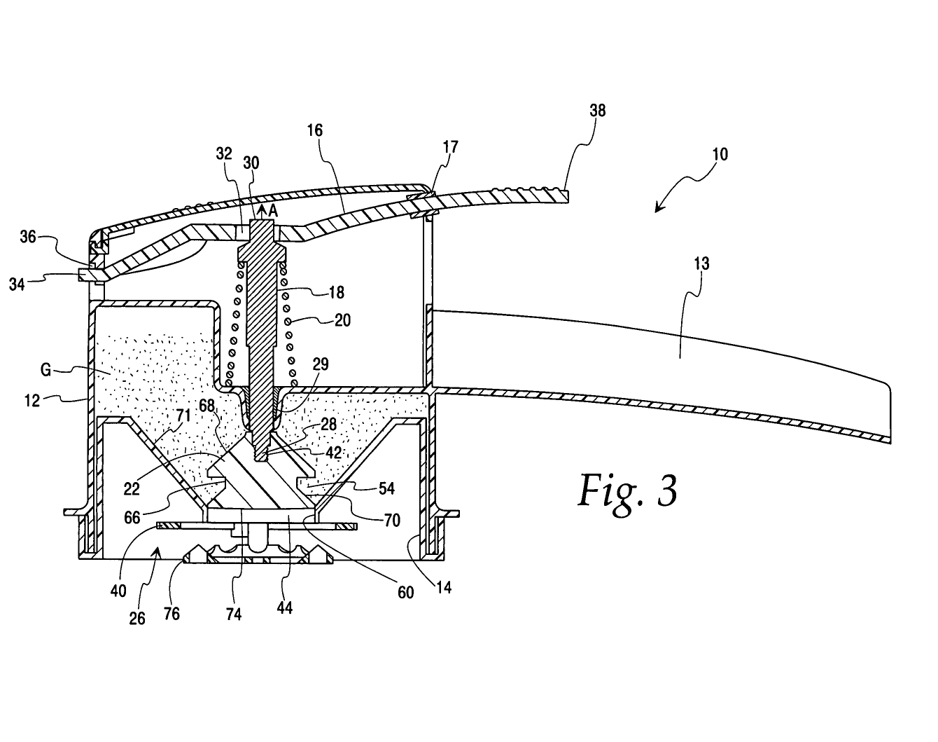

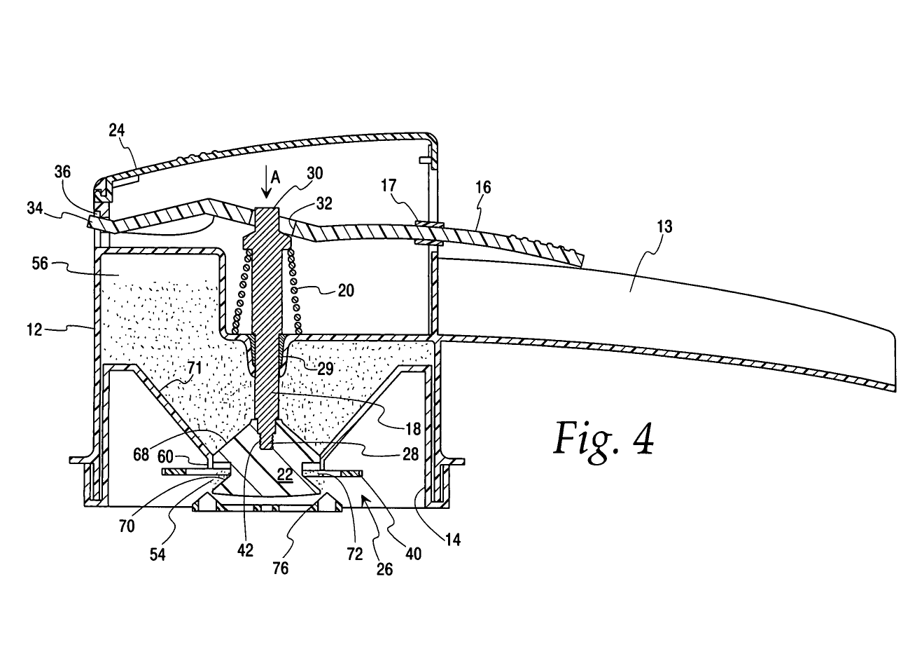

Turning to FIGS. 1-4, the overall assembly of a dispensing device 10 in accordance with the present invention is illustrated. Dispensing device 10 is depicted in perspective view in FIG. 1. An exploded view of device 10 is provided in FIG. 2a to illustrate the assembly of the components of dispensing device 10, which include a reservoir top member 12 with an integral handle 13; a reservoir floor member 14; an actuator assembly 15 composed of an actuator thumb lever 16 with a cushioning band 17, an actuator shaft 18, an actuator biasing member depicted as a biasing spring 20, and a dispensing member 22; an actuator retention cover 24; and a diffuser 26. In FIGS. 3 and 4, device 10 is depicted in side cross-sectional elevation views in a metering orientation and a dispensing orientation, respectively. Although the components of device 10 may be composed of any suitable material to facilitate their respective functions in accordance with the invention, reservoir top member 12, handle 13, reservoir floor member 14, thumb lever 16, actuator retention cover 24, and diffuser 26 are preferably substantially composed of a substantially rigid, food-safe material, such as a food-grade polymer, and formed by a suitable manufacturing process such as injection molding. The food-safe material used is preferably translucent, especially for reservoir top member 12, so that the level of granular seasoning material in device 10 can be visually discerned through the sides of reservoir top member 12. Dispensing member 22 is also preferably substantially composed of a substantially rigid, food-safe material such as a food grade polymer, which may also be injection molded, while actuator shaft 18 and biasing spring 20 are preferably composed of steel. Thumb lever cushioning band 17 is preferably a band of resilient material.

The steps of assembling actuator assembly 15 will now be described with reference to FIGS. 2a-2d, 3 and 4. In accordance with a preferred method of assembling actuator assembly 15, an actuator shaft 18 is first inserted through spring 20, aligning threaded lower end 28 of actuator shaft 18 with an actuator sleeve 29 in reservoir top member 12. Then, a tab 30 at the upper end of actuator shaft 18 is inserted into a longitudinal slot 32 in thumb lever 16, and a fulcrum connector 34 of thumb lever 16 is seated in a fulcrum receptacle 36 of reservoir top member 12, reaching a partially assembled configuration depicted in FIG. 2b. In this configuration, as in the fully assembled configuration depicted in FIGS. 1, 3, and 4, actuator shaft 18 is constrained by actuator sleeve 29 to move only in an axial direction, i.e., upwardly and downwardly along a common axis of shaft 18 and sleeve 29 as illustrated by arrows A in FIGS. 3 and 4, and thumb lever 16 is constrained to move only pivotally with respect to fulcrum receptacle 36 by the seating of fulcrum connector 34 in fulcrum receptacle 36. Therefore, it will be noted that to avoid locking of actuator assembly 15 that would prevent normal operation of device 10, slot 32 must be made sufficiently longer than the transverse dimension of tab 30 to allow for at least the full range of transverse motion of slot 32 relative to tab 30 that occurs as thumb lever 16 is pivoted between a rest position depicted in FIG. 3 and an actuation position depicted in FIG. 4. However, for ease of assembly, it is advantageous for the distal end of slot 32, with respect to fulcrum connector 34, to contact tab 30 at a position in which spring 20 is partially compressed, fulcrum connector 34 is seated in fulcrum receptacle 36, and shaft 18 is engaged in sleeve 29, as depicted in FIG. 2b. In this manner, the partially assembled components automatically lock in the illustrated stable position, in which shaft 18 is prevented from disengaging from sleeve 29, fulcrum connector 34 is prevented from unseating from fulcrum receptacle 36, and slot 32 is prevented from disengaging from tab 30, thus holding the components together and freeing a user's hands to retrieve actuator retention cover 24.

Then, a thumb paddle 38 of thumb lever 16 is depressed to allow sufficient clearance for the attachment of cover 24 to reservoir top member 12, cover 24 is attached, and thumb paddle 38 is released, preferably resulting in contact of thumb lever 16 on cover 24 with spring 20 in compression, as depicted in FIG. 2c, and also shown in the fully assembled device 10 as depicted in FIG. 3. The contact of thumb lever 16 on cover 24 relieves the distal end of slot 32 from bearing against tab 30 during normal operation and reduces the likelihood of stress or impact damage to slot 32 from frequent or prolonged contact on tab 30. In turn, to prevent stress or impact shock that could cause damage or wear to cover 24 itself, or to the portion of thumb lever 16 that contacts cover 24, band 17 is advantageously positioned at the contact location on thumb lever 16, as best illustrated in FIGS. 3 and 2b. Band 17 increases the functional life span of thumb lever 16 and/or cover 24, and the wear prevention achieved by band 17 prevents any plastic material from thumb lever 16 or cover 24 from scraping, chipping, or otherwise wearing off of those components, as well as preventing roughening of the contact surfaces of thumb lever 16 and cover 24.

The configuration shown in FIG. 2c having been reached, a threaded end 28 of actuator shaft 18 protrudes downwardly out of sleeve 29 just enough to permit threaded end 28 to be completely screwed into a threaded hole 42 of dispensing member 22, without the need to push thumb lever 16 downward from its position bearing against cover 24, but still leaving substantially no clearance between the top of dispensing member 22 and the bottom of sleeve 29. Thus, no substantial part, and preferably none, of the compressive load of spring 20 is borne by the threads of shaft 18 and dispensing member 22 during use, thus reducing undue thread strain or wear. On the other hand, the substantial lack of clearance between dispensing member 22 and sleeve 29 permits cover 24 to be easily removed from the assembled device 10 without the need to simultaneously depress thumb lever 16, as the compressive load of spring 20 will ease onto the threads of shaft 18 and dispensing member 22 with substantially no axial displacement of shaft 18, thus preventing any sudden recoil of thumb lever 16 when cover 24 is removed. In this manner, although the threads do end up bearing the compressive load of spring 20 when cover 24 is removed, they are protected from any impact shock when the spring load is shifted onto them. Still, during disassembly of device 10, once one of cover 24 or dispensing member 22 has been removed, thumb lever 16 should be depressed during removal of the other to avoid rapid recoil of the components of actuator assembly 15 to the locked position depicted in FIG. 2b.

After actuator assembly 15 has been fully assembled, the remaining steps of the assembly of device 10 may be performed, as illustrated in FIGS. 2d and 3. Reservoir top member 12 is inverted and filled with granular seasoning material G to a level that will not interfere with the attachment of reservoir floor member 14, which level may be indicated on the side of reservoir top member 12 by a fill line 43 (see FIGS. 2b and 2c), as depicted in FIG. 2d. Then, reservoir floor member 14 is attached to reservoir top member 12 in a tool-less manner, for example by a twist-lock connection (not shown). Finally, diffuser 26 may be attached to the bottom of reservoir floor member 14, below a dispensing outlet 44 formed in floor member 14, at any time during the assembly of device 10, for example by a twist-lock connection in which locking prongs (not shown) of reservoir floor member 14 are inserted through connection slots 48 of a connector portion 40 of diffuser 26, and diffuser 26 is rotated until one of the locking prongs snaps over one of detents 52 on diffuser 26, thus yielding the fully assembled configuration shown in FIGS. 1, 3 and 4.

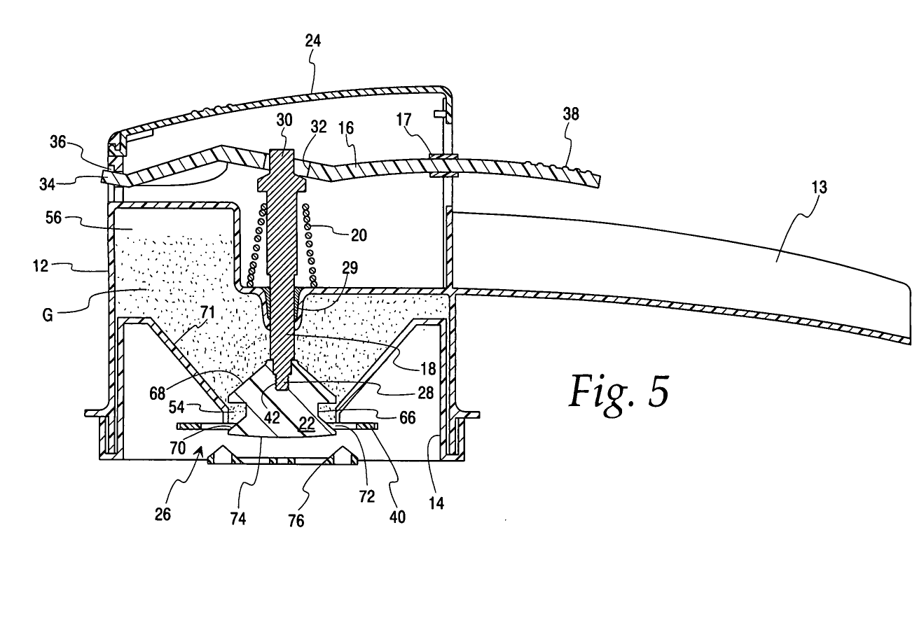

The operation of actuator assembly 15 will now be described. When actuator assembly 15 is in a metering position shown in FIG. 3, a metering chamber 54 of dispensing member 22 is in communication with a reservoir 56 defined by reservoir top member 12 and reservoir floor member 14, to permit a metered quantity of a granular material contained in reservoir 56 to enter metering chamber 54. Then, a user grips handle 13, positions device 10 over a target area A, which may for example be a hamburger patty H as depicted in FIG. 10, and while maintaining a grip on handle 13 to keep reservoir 56 in a steady position, applies thumb pressure to thumb paddle 38 to depress thumb lever 16. Preferably, the material and dimensions of thumb lever 16 are configured so that thumb lever 16 will flex somewhat when a force is applied to thumb paddle 38, before transmitting the necessary force to overcome the compressive preload on spring 20, thus giving thumb paddle 38 a “soft” feel. Additionally, thumb paddle 38 may be provided with raised gripping ribs 58 to prevent the user's thumb from sliding off of thumb paddle 38 when depressing thumb lever 16. When thumb lever 16 is depressed, actuator assembly 15 moves from the metering position depicted in FIG. 3 to a dispensing position depicted in FIG. 4. Preferably, before reaching the dispensing position, dispensing member 22 first passes through a choke position shown in FIG. 5, in which metering chamber 54 is cut off from reservoir 56 and from the exterior of device 10 by a sleeve portion 60 of dispensing outlet 44, thus preventing granular seasoning material G from simultaneously flowing into metering chamber 54 from reservoir 56 and out of metering chamber 54 onto target area A, which, if occurring to a significant extent, would tend to undermine the metering function of dispensing member 22.

When a user has fully depressed thumb lever 16, thumb paddle 38 contacts the top of handle 13, preventing further pivotal movement of thumb lever 16 and providing the user with a tactile indication that dispensing member 22 is in the dispensing position. A metered quantity of granular seasoning material G then flows out of metering chamber 54, over and through diffuser 26 as will be described below in detail, and onto target area A. The user then releases thumb pressure from thumb paddle 38, allowing actuator assembly 15 to return to the metering position, at which point metering chamber 54 is refilled with granular seasoning material G from reservoir 56, and the dispensing cycle may begin again.

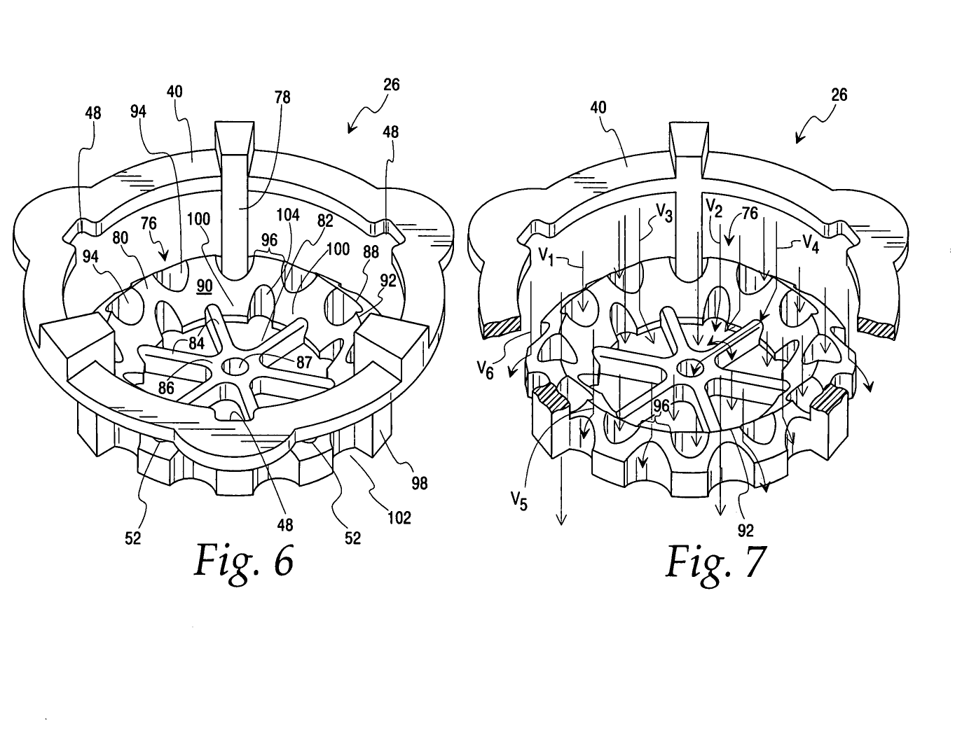

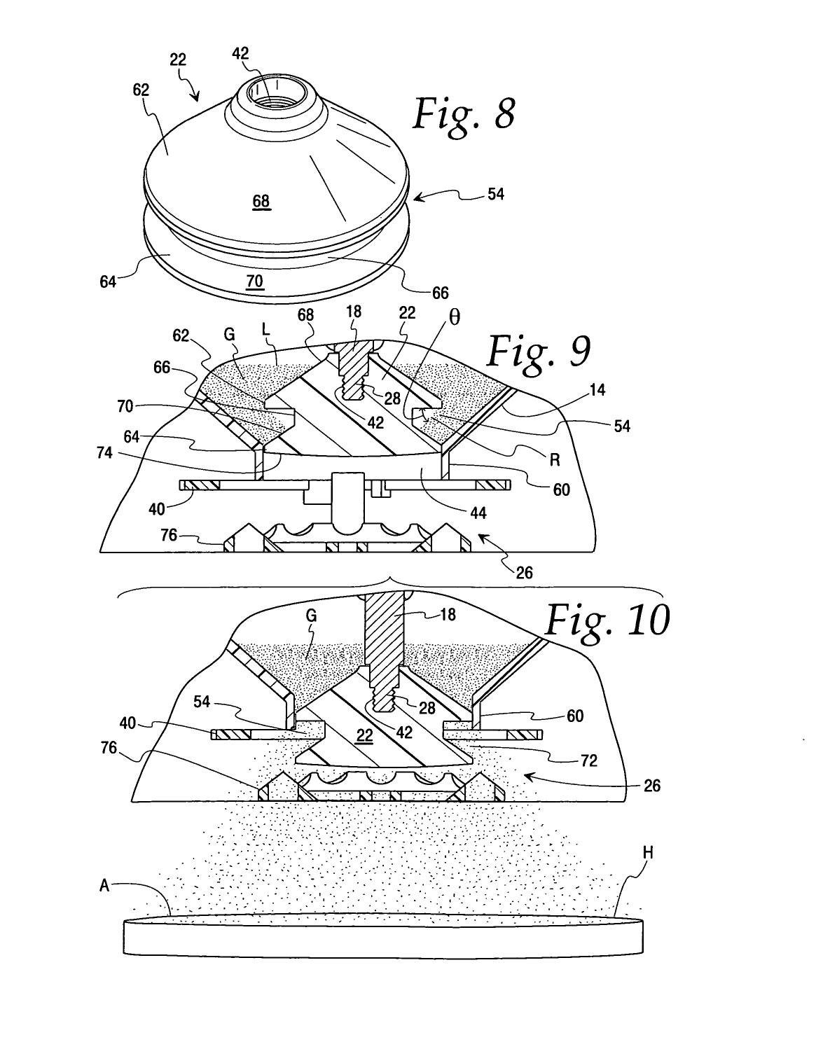

With reference to FIGS. 6-10, the components that are configured to directly contact granular seasoning material to effect even dispensing of a metered amount of material onto a target area will now be described in detail. A preferred embodiment of dispensing member 22 is illustrated in FIG. 8. As shown, dispensing member 22 is comprised of a generally frustoconical upper extension 62 joined to a generally frustoconical lower extension 64 by a generally cylindrical central portion 66, upper and lower extensions 62, 64 having the same base diameter, corresponding to the diameter of dispensing outlet 44. It will be understood that central portion 66 is not essential to the dispensing functionality of dispensing member 22, but rather serves as a spacer between upper extension 62 and lower extension 64, to expand the volume of metering chamber 54 to accommodate a desired metered quantity of granular seasoning material G. The volume of metering chamber 54 can be as desired, which volume determines the amount of granular seasoning material dispensed. A different dispensing member 22, having a different volume (either a greater or lesser volume) compared to the volume of metering chamber 54 of dispensing member 22 can be substituted for dispensing member 22 to either increase or decrease the amount of granular seasoning material G dispensed during a single dispensing operation of device 10. The diameter of cylindrical central portion 66, corresponding to the diameter of the top of lower extension 64, is smaller than the base diameter of upper extension 62 and lower extension 64, thus defining metering chamber 54 in the illustrated example as an annular cavity with an irregular trapezoidal cross section, as seen in FIGS. 3, 4, 8 and 9. It will be understood, however, that the exact geometry of upper extension 62 and lower extension 64 is secondary to their function of guiding the metering and dispensing movements of material G under the force of gravity. Thus, the shape of an upper surface 68 of upper extension 62 need not necessarily be frustoconical, rather, other shapes of upper surface 68 with downward slopes in radially outward directions (“radially” to be understood herein as radially with respect to the axis of shaft 18 and sleeve 29), suitable to direct material G on upper surface 68 to fall towards metering chamber 54 when actuator assembly 15 is in the metering position, are also within the scope of the invention. Likewise, although the shape of an upper surface 70 of lower extension 64 is depicted as frustoconical, other shapes configured to direct material G out of metering chamber 54, and toward diffuser 26 in a manner described below, when actuator assembly 15 is in the dispensing position, are also within the scope of the invention.

Depicted in FIG. 9 is an enlarged, fragmentary cross-sectional view of dispensing member 22, reservoir floor member 14 including dispensing outlet 44, and diffuser 26, with dispensing member 22 in the metering position and reservoir 56 containing material G at a level L. Due to the radially outward and downward slope of upper surface 68 of upper extension 62 of dispensing member 22, and the radially inward and downward slope of a generally inverted frustoconical floor surface 71 as shown in FIGS. 2a, 3-5, a granular seasoning material G at any location within reservoir 56 tends to be directed towards metering chamber 54. Nonetheless, it is understood that granular seasoning material G in reservoir 56 typically may not completely fill metering chamber 54, even when metering chamber 54 lies entirely below the level L of material G in reservoir 56. Rather, a commonly observed phenomenon is that material G in metering chamber 54 may form a “repose surface” R having a non-zero “repose angle” A with respect to a horizontal plane. Without wishing to be bound by theory, it is believed that this is due to the natural resistance of a granular material to flowing upward to fill tight interior spaces. Depending on the geometry of metering chamber 54, the repose angle phenomenon may result in a metered quantity of material G corresponding to a volume that is less than the entire volume of metering chamber 54. However, this is not a significant concern, as the repose angle phenomenon affects the occupied volume of metering chamber 54 in a consistent manner for a given material G, so that the dispensed metered quantity will be substantially consistent. The approximate dispensed metered quantity may be determined either by empirical measurement or by calculating the occupied portion of the volume of metering chamber 54 as a function of a repose angle θ that is either observed or known as a property of the particular material G.

With reference to FIG. 10, the components depicted in FIG. 9 are shown with dispensing member 22 in the dispensing position and a metered quantity of material G falling out of metering chamber 54, passing through diffuser 26, and coming to rest in a substantially even distribution on a target area A, which in this case is illustrated as the top surface of a hamburger patty H. It will be noted that the shape of the opening through which material G exits metering chamber 54 is not the horizontal disk (i.e., area with a circular perimeter and no interior void) defined by dispensing outlet 44, but rather a vertical cylinder defined by an annular outflow opening 72 of dispensing member 22, so that material G exits only at the periphery of metering chamber 54 in a generally radially outward and downward direction under the force of gravity. As such, without being redirected, none of material G exiting metering chamber 54 would tend to fall onto a circular area located directly below dispensing outlet 44 within target area A, and a central void with no seasoning would thus be left in the center of target area A, the central void generally shaped like dispensing outlet 44 and the solid bottom surface 74 of dispensing member 22. This result is undesirable when the object to be seasoned does not include a central void in its target surface, as in the illustrated case of hamburger patty H. The present inventors have thus avoided a central seasoning distribution void by providing a diffuser 26 that guides some of material G exiting metering chamber 54 toward the area directly below dispensing outlet 44, in addition to performing other guiding functions, as will be described in the following paragraphs.

The geometric features of diffuser 26 are shown in enlarged detail in FIG. 6. In particular, diffuser 26 includes a baffle member 76 attached to connector portion 40 by longitudinal ribs 78. Baffle member 76 includes a ring portion 80 defining a generally open interior area 82 and a plurality of spokes 84 attached to ring portion 80 at the inner perimeter of ring portion 80 and joined together at a hub 86 defining a longitudinal hub aperture 87 located approximately at the center of interior area 82. Ring portion 80 itself comprises significant geometric features including an upper outer surface 88 and an upper inner surface 90 meeting at an apex to define a central ridge 92. Referring back to FIGS. 3, 8 and 9, it will be noted that central ridge 92 has a slightly larger diameter than that of dispensing member 22 and is generally aligned coaxially with dispensing member 22 when diffuser 26 is attached to reservoir floor member 14, an arrangement which allows for some grains of material G exiting metering chamber 54 to contact diffuser 26 radially inward of central ridge 92 and other grains of material G radially outward of central ridge 92. Upper outer and inner surfaces 88, 90 are depicted as generally frustoconical, though their precise geometry is secondary to their purpose of guiding some of the dispensed grains of material G radially away from, and other grains toward interior area 82, respectively, and other geometries which are adapted to perform this function as part of a baffle member that produces a substantially even distribution of grains dispensed from a dispensing member according to the invention onto a target area are also within the scope of the invention. Ring portion 80 also includes a plurality of spaced-apart apertures 94 extending longitudinally through ring portion 80, the apertures approximately centered at points on central ridge 92, so that central ridge 92 is discontinuous, being composed of a plurality of spaced-apart central ridge segments 96 separated by ring apertures 94. The outer and inner perimeters of ring portion 80 have wavy profiles comprising exterior and interior teeth 98, 100 that alternate with exterior and interior notches 102, 104, respectively, thus varying the distance to which a grain is directed radially outwardly or inwardly of central ridge 92, respectively, before the grain loses contact with ring portion 80 and begins to fall freely, depending on where and with what trajectory the grain initially hits ring portion 80. It will be noted that, while ring portion 80 is depicted as substantially circular, the term “ring” as used herein is intended to refer to any endless, elongate member defining a generally open interior area, and a ring portion having some other shape, e.g., elliptical or polygonal, may be preferable to a circular ring portion in some applications, depending, for example, on the shapes of the target area, dispensing member, and dispensing outlet, as will be discussed in more detail below.

The above-described geometric features of diffuser 26 enable diffuser 26 to redirect the paths of some grains of material G exiting metering chamber 54 radially inwardly to varying extents, to permit some grains of material G to fall through diffuser 26 without altering their paths, and to redirect the paths of some grains of material G radially outwardly to varying extents, to effect a substantially even distribution of material G onto a target area. The manner in which diffuser 26 redirects some grains of material G is illustrated in FIG. 7, in which a plurality of vectors represent the path directions taken by individual grains falling onto ring portion 80 at various locations, vectors V₁-V₆ being representative examples of six different basic types of path that a grain will follow depending on where the grain hits ring portion 80.

In particular, vector V₁ in FIG. 7 shows the unaltered path of a grain falling straight through one of apertures 94. Thus, apertures 94 prevent the undesirable result of a void portion of target area A shaped roughly like ring portion 80 receiving no seasoning, by allowing some grains to pass directly through ring portion 80.

With reference to vectors V₂-V₄ in FIG. 7, three different types of radially inward grain path redirection are illustrated. Vector V₂ shows the path of a grain hitting upper inner surface 90 at the angular location of one of interior notches 104, sliding down upper inner surface 90, and then falling through interior area 82 adjacent one of interior notches 104. Vector V₃, on the other hand, shows the path of a grain hitting upper inner surface 90 at the angular location of one of interior teeth 100, sliding down upper inner surface 90, and then falling through interior area 82 adjacent one of interior teeth 100, which extends radially inwardly into interior area 82. Thus, a grain following vector V₃ is directed to travel slightly further in the radially inward direction before coming to rest on a target area than a grain following vector V₂. Vector V₄ illustrates a less probable type of path that will be followed by a relatively small number of grains that hit the upper inner surface 90 of ring portion 80 at just the right location to slide down upper inner surface 90 and onto one of spokes 84, then travelling a certain distance along spoke 84 before falling through interior area 82, either to one of the sides of spoke 84, or in the rarest of cases, through hub aperture 87. It will be readily understood that, due to the thinness and tapered cross-sectional shape of spoke 84, most grains will not make it very far along spoke 84 before falling off to one side or the other, that the proportion of grains travelling a given distance along spoke 84 before falling through interior area 82 decreases as the given distance increases, and that very few grains, representing the smallest proportion of the total dispensed, will actually traverse the full length of spoke 84 to fall through hub aperture 87. In this manner, a relatively even distribution of grains across target area A is achieved, because each successively smaller radial distance from the center of target area A corresponds to a successively smaller differential area, thus requiring successively fewer grains for an even distribution. Put another way, the lateral spacing between adjacent spokes 84 is smaller at points on spokes 84 closer to hub 86, and therefore the number of grains required for an even distribution of grains across the lateral spacing between adjacent spokes 84 also decreases when approaching hub 86.

Similarly to vectors V₂ and V₃, vectors V₅ and V₆ illustrate the paths of grains hitting upper outer surface 88 at the angular locations of one of exterior notches 102 and one of exterior teeth 98, respectively, sliding down upper outer surface 88, and falling off of ring portion 80 adjacent one of exterior notches 102 and exterior teeth 98, respectively, a grain following vector V₆ thus being directed to travel slightly farther in the radially outward direction before coming to rest on a target area than a grain following vector V₅, thus distributing grains of seasoning material G to varying radially outward distances between the outer perimeter of ring portion 80 and the outer perimeter of target area A.

One skilled in the art will of course understand that, in general, practically none of the dispensed grains of material G will fall straight down onto target area A, as contact of a grain on diffuser 26 tends to impart either a radially inward or radially outward component to the velocity of the grain as it passes diffuser 26, and even the grains that pass through diffuser 26 without contacting diffuser 26 are imparted a radially outward velocity component by the slope of upper surface 70 of lower extension 64 of dispensing member 22. Therefore, the final location of grains coming to rest on target area A depends on the height at which the dispenser is held when dispensing. A user will thus determine from practice an approximate optimal height for dispensing, typically the lowest height at which some grains come to rest on target area A close to its outer perimeter, and consistently hold the dispenser at that approximate optimal height when dispensing. The stable operation of dispensers according to the invention beneficially assists a user in determining and consistently dispensing at this optimal height, as reservoir 56 is held stationary during the act of dispensing, in sharp contrast to the repeated rotational inverting motions required to use an existing baffle-based metering dispenser of the type mentioned previously.

From the foregoing it will be understood that the synergistic cooperation of dispensing member 22 and diffuser 26 produces the remarkable result that a quantity of grains initially dispensed only about the periphery of dispensing member 22 through annular outflow opening 72, in a radially outward and downward direction, is made to substantially evenly cover a target area, which extends both radially inwardly and radially outwardly from annular outflow opening 72, as does target area A of the illustrated hamburger patty H. More particularly, diffuser 26 may be used to evenly distribute material G over a target area that eclipses the entire downward projection of dispensing outlet 44, with no central void, also as in target area A of the illustrated hamburger patty H, as opposed to a bagel, donut, or onion ring, for example, by redirecting at least some grains to traverse a variety of radially inward distances ranging all the way to the approximate center of a downward projection of interior area 82 by the time they reach target area A.

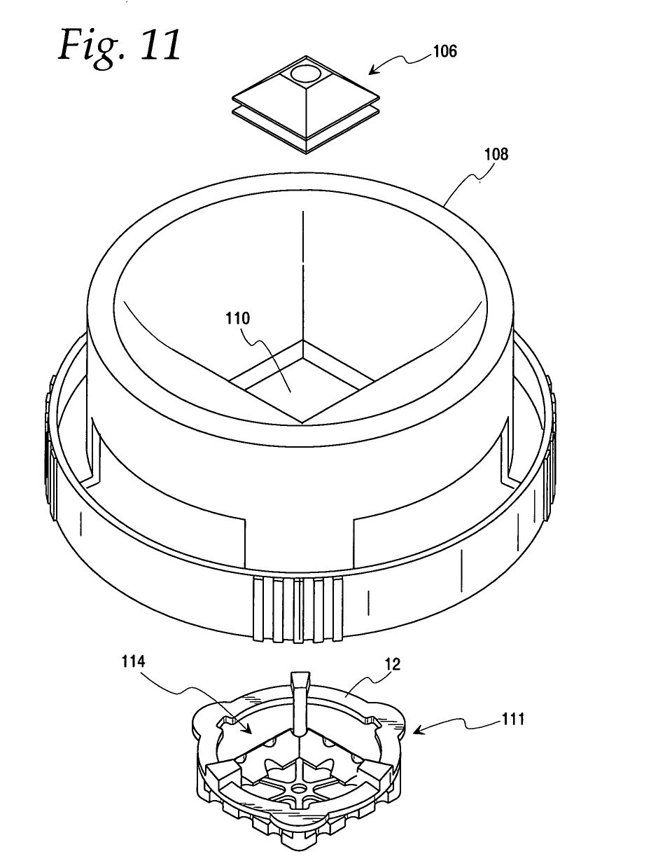

While the above described benefits of the invention have been illustrated and discussed with respect to generally disk-shaped dispensing member 22, dispensing outlet 44, and baffle member 76, the combination of which is well suited to distribute a metered quantity of material G over a generally disk-shaped target area, one skilled in the art will understand that other combinations of a dispensing member and a diffuser will be better suited to target areas of other shapes. For example, for a target area corresponding to the whole interior area within an ellipse or a polygon, it is believed that a dispensing member, dispensing outlet, and diffuser baffle member having a similar shape to that of the target area but smaller (i.e., of equal proportions and differing only in its smaller scale), the diffuser baffle member otherwise having comparable features to those of baffle member 76, will provide evenly distributed dispensing over the target area. Accordingly, depicted in FIG. 11 is an illustrative exploded view of an alternate dispensing member 106, an alternate reservoir floor member 108 having an alternate dispensing outlet 110, and an alternate diffuser 111 having a connecting portion 112 and an alternate baffle member 114, where each of dispensing member 106, dispensing outlet 110, and baffle member 114 has a generally square profile, for evenly distributing granular seasoning material onto a generally square target area such as, for example, a square hamburger patty or the face of a square deli sandwich. Advantageously, the modular construction and tool-less assembly of device 10 permits substitution of dispensing member 22 with a differently shaped (i.e., either of different proportions or different size, including a different volume of metering chamber 54) dispensing member simply by unscrewing dispensing member 22 and screwing on another dispensing member, while reservoir floor member 14 can be just as easily changed out for an alternate reservoir floor member having a differently shaped dispensing outlet to match the profile of the alternate dispensing member, the alternate floor member coupling with a corresponding alternate diffuser.

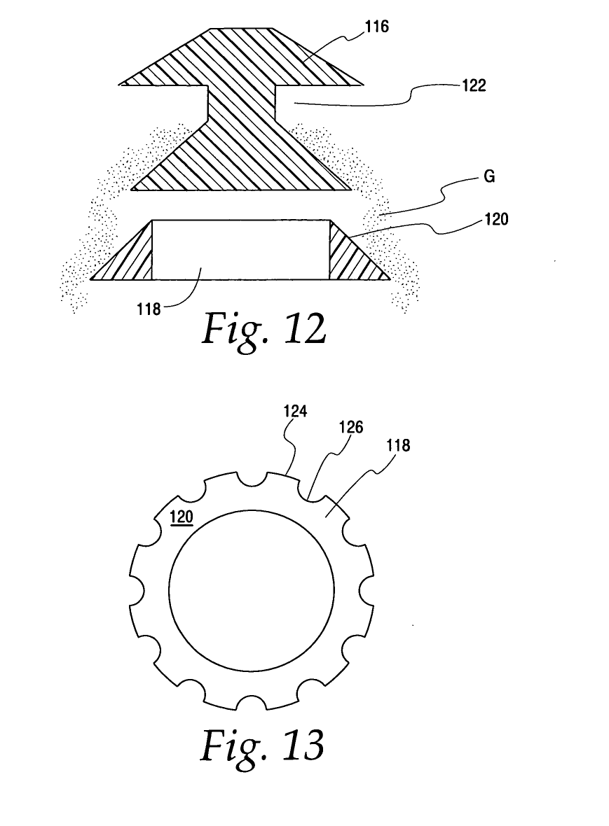

Additionally, for target areas that do include central voids, such as the top surface of a bagel or donut, one skilled in the art would understand that an appropriate diffuser would be adapted to omit or suitably limit the redirection of seasoning particles toward an area directly below the corresponding dispensing outlet, depending on the size and shape of the central void. For example, if the central void in the target area at least eclipses the outer perimeter of the diffuser, then a diffuser would only be necessary to vary the outward radial distribution. Directing grains toward an open interior area in the baffle member would be unnecessary and in fact undesirable, so that the proportional relationship of the appropriate dispensing member and the appropriate baffle member might more closely resemble that of dispensing member 116 and baffle member 118 (omitting a connecting portion for illustrative purposes) shown in a cross-sectional elevation view in FIG. 12, wherein an upper outer surface 120 of baffle member 118, sloped downwardly in radially outward directions, has an inner diameter smaller than the diameter of dispensing member 116, so that substantially all grains of seasoning material G exiting a dispensing cavity 122 would contact upper outer surface 120 and be directed radially outwardly. Variations in the peripheral profile of baffle member 118, such as outer peripheral teeth 124 and notches 126 illustrated in top plan view in FIG. 13, would be sufficient to provide the desired variation in outward radial distribution of seasoning material onto a target area below baffle member 118.

While the invention has been described with respect to certain preferred embodiments, as will be appreciated by those skilled in the art, it is to be understood that the invention is capable of numerous changes, modifications and rearrangements, and such changes, modifications and rearrangements are intended to be covered by the following claims.

What is claimed is:

1. A device for metered dispensing of granular seasoning material comprising:
a reservoir adapted to contain granular seasoning material in an interior thereof, the reservoir including a dispensing outlet;
a metered dispensing member having an axis and a metering chamber comprising a peripheral cavity in the metered dispensing member, the metered dispensing member mounted for axial linear movement relative to the reservoir through the dispensing outlet to and from a filling position and a dispensing position, in the filling position, at least a portion of the metering chamber disposed in communication with the reservoir for receiving into the metering chamber seasoning material contained in the reservoir, and in the dispensing position, at least a portion of the metering chamber disposed to the exterior of the reservoir, the metering chamber configured to permit gravity dispensing of particulate seasoning from the metering chamber when in the dispensing position.

2. The device of claim 1 wherein the peripheral cavity in the metered dispensing member substantially encircles the axis of the metered dispensing member.

3. The device of claim 1, further comprising:
a biasing member axially biasing the metered dispensing member to a biased position, the biased position being one of the filling position and the dispensing position; and
a manual actuator operatively connected to the metered dispensing member and adapted, when actuated, to move the metered dispensing member from the biased position to an actuation position, and, when released, to permit the biasing member to return the metered dispensing member to the biased position.

4. The device of claim 1, the biased position of the metered dispensing member being the filling position and the manual actuator adapted to move the metered dispensing member to the dispensing position when actuated.

5. The device of claim 1, further comprising
a lower portion of the metered dispensing member disposed below the metering chamber and when the metered dispensing member is in the filling position, the lower portion blocks the dispensing outlet to at least substantially prevent particulate material from passing through the dispensing outlet from the interior of the reservoir, and
an upper portion of the metered dispensing member disposed above the metering chamber and when the metered dispensing member is in the dispensing position, the upper portion blocks the dispensing outlet to at least substantially prevent particulate material from passing through the dispensing outlet from the interior of the reservoir.

6. The device of claim 5, the lower and upper portions of the metered dispensing member each having a peripheral portion with a cross-sectional shape matching a shape of the dispensing outlet, the peripheral portion configured to pass through the dispensing outlet with at least substantially no peripheral clearance to cover the dispensing outlet when overlapping the peripheral profile of the dispensing outlet.

7. The device of claim 6,
the dispensing outlet comprising a sleeve having an axial length,
a cross-sectional shape of the sleeve defining said shape of the dispensing outlet and being at least substantially uniform along the axial length, and
the sleeve configured, when the metered dispensing member is at an intermediate position between the filling position and the dispensing position, to cover the metering chamber to at least substantially prevent particulate material from flowing into the metering chamber from the reservoir or out of the metering chamber to the exterior of the reservoir.

8. The device of claim 6, the cross-sectional shape of the peripheral portions of the metered dispensing member and the shape of the dispensing outlet being generally circular.

9. The device of claim 6, the cross-sectional shape of the peripheral portions of the metered dispensing member and the shape of the dispensing outlet being generally polygonal.

10. The device of claim 9, the cross-sectional shape of the peripheral portions of the metered dispensing member and the shape of the dispensing outlet being generally square.

11. The device of claim 1, the dispensing outlet being generally horizontally disposed in a bottom wall of the reservoir, further comprising
a diffuser disposed outside of the reservoir and spaced downwardly from the dispensing outlet,
the diffuser including a particle flow baffle member,
the baffle member including a ring portion having a shape generally geometrically similar to, coaxial with, and larger than the shape the dispensing outlet,
the ring portion defining a generally open interior area,
the baffle member configured to contact at least some of a metered quantity of particles dispensed from the metering chamber in the dispensing position and to alter the paths of at least some of the particles to cause the quantity of particles to be generally uniformly dispensed onto a target area generally located below the diffuser.

12. The device of claim 11, the ring portion configured to direct at least some of the particles to fall through the interior area and at least some of the particles to fall outside the periphery of the ring portion.

13. The device of claim 11, the target area having a shape generally geometrically similar to, coaxial with, and larger than the shape of the combined area of the ring portion and interior area.

14. The device of claim 11, the baffle member further comprising a plurality of spokes generally extending from the center of the interior area to the ring portion.

15. The device of claim 14, the spokes being connected to a hub disposed proximate to the center of the interior area, further comprising an aperture extending longitudinally through the hub.

16. The device of claim 11, the ring portion comprising an upper outer surface and a generally opposed upper inner surface defining the outer and inner periphery of the ring portion, respectively, the upper outer and inner surfaces generally meeting at an apex to define a central ridge.

17. The device of claim 16, further comprising a plurality of apertures extending longitudinally through the ring portion, the central ridge being discontinuous and comprising a plurality of central ridge segments extending between adjacent apertures.

18. The device of claim 17, the ring portion having a radial width that is generally greater at the angular locations of the apertures than at the angular locations of the central ridge segments.

19. The device of claim 1, the dispensing outlet being formed in a detachable portion of the reservoir and the reservoir being adapted for detaching of the detachable portion and attaching of a different detachable portion including a different dispensing outlet having a different shape, and
the dispensing member being detachable from the device and the device being adapted for attachment of a different dispensing member having a shape corresponding to the different dispensing outlet.

20. The device of claim 11, the diffuser being detachable from the device and the device being adapted for attachment of a different diffuser having a different shape.

21. The device of claim 1, further comprising a handle attached to the reservoir proximate to the manual actuator, the handle and manual actuator configured to permit a user to support the device by grasping the handle with one hand while actuating the actuator with the same hand.

22. The device of claim 21, the manual actuator comprising a thumb lever disposed above the handle, the thumb lever mounted pivotally with respect to the reservoir, pivotally and slidingly connected to a dispensing shaft that is integrally attached to the metered dispensing member, and configured to be pivotally depressed by a downward force applied by a user's thumb to cause the dispensing shaft and metered dispensing member to move downward in an axial direction to move the metered dispensing member to the dispensing position.

23. The device of claim 1, the reservoir composed of a translucent material so that the amount of particulate material in the reservoir is visually discernible.

24. The device of claim 1, the reservoir, dispensing member, and manual actuator composed of substantially rigid materials.

25. The device of claim 23 or 24, the reservoir composed of a food grade plastic.

26. A method for metered dispensing of particulate material, comprising
providing a metered granular seasoning material dispensing device comprising:
a reservoir adapted to contain granular seasoning material in an interior thereof, the reservoir including a dispensing outlet;
a metered dispensing member having an axis and a metering chamber comprising a peripheral cavity in the metered dispensing member, the metered dispensing member mounted for axial linear movement relative to the reservoir through the dispensing outlet to and from a filling position and a dispensing position, and in the filling position, at least a portion of the metering chamber disposed in communication with the reservoir for receiving into the metering chamber seasoning material contained in the reservoir, and in the dispensing position, at least a portion of the metering chamber disposed to the exterior of the reservoir, the metering chamber configured to permit gravity dispensing of particulate seasoning from the metering chamber when in the dispensing position; and
a manual actuator operatively connected to the dispensing member;
providing granular seasoning material in the reservoir;
positioning the dispensing outlet over a target area;
actuating the manual actuator to move the manual actuator from a default position to an actuation position and to move the metered dispensing member from an initial one of the filling position and the dispensing position to the other of the filling position and the dispensing position;
returning the manual actuator to the default position to return the metered dispensing member to the initial position; and
when the metered dispensing member is moved to the dispensing position with a metered quantity of the granular seasoning material in the metering chamber, allowing the metered quantity of the granular seasoning material to flow out of the metering chamber by the force of gravity and to come to rest on the target area.

27. The method of claim 26, wherein the peripheral cavity substantially encircles the axis of the metered dispensing member.

28. The method of claim 26, the providing the dispensing device further comprising providing a biasing member axially biasing the metered dispensing member to the initial position and biasing the manual actuator to the default position; and the returning the manual actuator to the default position comprising releasing the manual actuator in the actuation position to permit the biasing member to return the metered dispensing member to the initial position and the manual actuator to the default position.

29. The method of claim 26, the particulate material being a granular seasoning and the target area being a top surface of a food item.

30. The method of claim 28, the biased position being the filling position and the actuating the manual actuator causing the metered dispensing member to move from the filling position to the dispensing position.

31. The method of claim 26, said providing a dispensing device comprising
providing a plurality of interchangeable, detachable portions of the reservoir, wherein said dispensing outlet is formed in one of the detachable portions, each other detachable portion having a differently shaped dispensing outlet formed therein;
selecting the detachable portion having said dispensing outlet from the plurality of detachable portions; and
attaching said detachable portion to the device to form the reservoir.

32. The method of claim 26, said providing a dispensing device comprising
providing a plurality of differently shaped interchangeable, detachable metered dispensing members including said metered dispensing member;
selecting said metered dispensing member from the plurality of metered dispensing members; and
operatively connecting said metered dispensing member to the manual actuator.

33. The method of claim 26, said providing a dispensing device further comprising
providing a diffuser disposed outside of the reservoir and spaced downwardly from the dispensing outlet,
the diffuser including a particle flow baffle member,
the baffle member including a ring portion having a shape generally geometrically similar to, coaxial with, and larger than the shape of the dispensing outlet,
the ring portion defining a generally open interior area; and
when the dispensing member is in the dispensing position with the metered quantity of particulate material in the metering chamber, allowing at least some of the metered quantity of particles to contact the baffle member to alter the paths of the particles contacting the baffle member to cause the quantity of particles to be generally uniformly dispensed onto the target area.

34. The method of claim 33, said providing a diffuser comprising providing a plurality of interchangeable, detachable diffusers of different shapes including said diffuser;
selecting said diffuser from the plurality of diffusers; and
attaching said diffuser to the outside of the reservoir below the dispensing outlet.

35. The method of claim 33, the target area being a generally circular top surface of a hamburger patty.

36. The method of claim 33, the target area being a generally square top surface of a hamburger patty.

37. A method of making a device for metered dispensing of particulate material comprising
forming a reservoir adapted to contain granular seasoning particles in an interior thereof;
forming a dispensing outlet in the reservoir;
forming a metered dispensing member having an axis and an outer peripheral shape matching the inner peripheral shape of the dispensing outlet to permit the dispensing member to pass through the dispensing outlet with substantially no clearance between the outer periphery of the dispensing member and the inner periphery of the dispensing outlet;
movably mounting the metered dispensing member within the reservoir for bidirectional axial movement through the dispensing outlet to and from a filling position and a dispensing position; and
forming a metering chamber in the metered dispensing member by creating a peripheral cavity in the metered dispensing member substantially encircling the axis of the metered dispensing member, in the filling position, at least a portion of the metering chamber being disposed in communication with the reservoir, and in the dispensing position, at least a portion of the metering chamber being disposed in communication with the exterior of the reservoir.

38. The method of claim 37, further comprising
configuring a biasing member operatively connected to the metered dispensing member to axially bias the metered dispensing member to a biased position, the biased position being one of the filling position and the dispensing position; and
configuring a manual actuator movably mounted with respect to the reservoir to move to and from a default position and an actuation position, operatively connected to the metered dispensing member, and adapted, when actuated, to move the metered dispensing member from the biased position to the other of the filling position and the dispensing position, and when released, to permit the biasing member to return the metered dispensing member to the biased position and the manual actuator to the default position.

39. The method of claim 37, further comprising
forming a diffuser including a particle flow baffle member;
forming in the baffle member a ring portion having a shape generally geometrically similar to and larger than the shape of the dispensing outlet;
forming an inner periphery of the ring portion to define a generally open interior area;
forming in the ring portion a plurality of inwardly sloped surfaces and outwardly sloped surfaces, the inwardly sloped surfaces configured to contact some of a metered quantity of particulate material dispensed from the metering chamber in the dispensing position and to alter the paths of particles of the particulate material contacting the inwardly sloped surfaces to cause the particles to fall through the generally open interior area, and the outwardly sloped surfaces configured to contact some of the metered quantity of particulate material and to alter the paths of particles of the particulate material contacting the outwardly sloped surfaces to cause the particles to fall radially outwardly of the ring portion; and
attaching the diffuser to the outside of the reservoir below the dispensing outlet with the baffle member spaced downwardly from and generally coaxial with the dispensing outlet.

40. The method of claim 39, further comprising
forming in the ring portion a plurality of apertures extending longitudinally through the ring portion, the apertures disposed between the inner periphery of the ring portion and an outer periphery of the ring portion, to permit some of the metered quantity of particulate material to fall through the apertures without contacting the sloped surfaces.

41. The method of claim 39, further comprising
forming in the baffle member a plurality of spokes extending from the inner periphery of the ring portion approximately to the center of the generally open interior area.

42. The method of claim 41, further comprising
forming in the baffle member a hub approximately at the center of the generally open interior area, the spokes connected to the hub, and an aperture extending longitudinally through the hub.
